(19) United States
(12) Patent Application Publication
(10) Pub. No.: US 2011/0204732 A1
(43) Pub. Date: Aug. 25, 2011

(54) LINEAR MOTOR AND MOBILE DEVICE HAVING LINEAR MOTOR

(76) Inventors: Hideaki Miyamoto, Gifu (JP); Yoshinori Shishida, Gifu (JP); Kazunari Honma, Gifu (JP)

(21) Appl. No.: 13/126,349

(22) PCT Filed: Aug. 10, 2009
(86) PCT No.: PCT/JP2009/064106

§ 371 Date: Apr. 27, 2011

(30) Foreign Application Priority Data
Oct. 28, 2008 (JP) 2008-277456

(51) Int. Cl. H02K 33/00

(52) U.S. Cl. 310/25

(57) ABSTRACT

A linear motor capable of attaining thinning is obtained. This linear motor (100) includes a spiral coil (141, 142, 441, 442); and a movable portion (120, 220), including a first pole face (121a) having a first polarity and a second pole face (122a) having a second polarity different from the first polarity on a surface opposed to the spiral coil, provided to be movable in a direction along the surface of the spiral coil.

### TECHNICAL FIELD

The present invention relates to a linear motor and a mobile device having a linear motor.

### BACKGROUND ART

A vibrating motor including a movable portion vibrating by electromagnetic force from a coil is known in general.

Japanese Patent Laying-Open No. 2006-68688 discloses a vibrating actuator (vibrating motor) including a movable portion formed by a discoidal magnet and a coil arranged to surround the movable portion. In the vibrating actuator described in the aforementioned Japanese Patent Laying-Open No. 2006-68688, the coil having a large thickness in the vertical direction is arranged to surround a discoidal movable portion, and formed to linearly move the discoidal movable portion in the vertical direction (thickness direction of the movable portion) by electromagnetic force from the coil.

Japanese Patent Laying-Open No. 2004-174309 discloses a vibrator including a permanent magnet, an oscillator arranged to be opposed to the permanent magnet and a movable coil coupled to the oscillator and cylindrically formed. In the vibrator described in the aforementioned Japanese Patent Laying-Open No. 2004-174309, a winding surface of the coil is arranged in a direction orthogonal to a bar-shaped guide rail extending in the direction of movement of the oscillator, and the movable coil is formed to vibrate with the oscillator in a direction along the guide rail.

### PRIOR ART

### Patent Document

Patent Document 1: Japanese Patent Laying-Open No. 2006-68688

Patent Document 2: Japanese Patent Laying-Open No. 2004-174309

### SUMMARY OF THE INVENTION

### Problems to be Solved by the Invention

The vibrating actuator disclosed in the aforementioned Japanese Patent Laying-Open No. 2006-68688 is so formed that the discoidal movable portion moves in the vertical direction (thickness direction of the movable portion) with the coil having the large thickness in the vertical direction, and hence there is such a problem that it is difficult to attain thinning of the apparatus.

In the vibrator disclosed in the aforementioned Japanese Patent Laying-Open No. 2004-174309, it follows that the winding surface of the cylindrical movable coil is arranged in the direction orthogonal to the direction of movement (direction along the guide rail) of the movable coil. Therefore, the length of the winding surface of the movable coil in the height direction enlarges, and hence there is such a problem that it is difficult to attain thinning of the apparatus.

The present invention has been proposed in order to solve the aforementioned problems, and an object of the present invention is to provide a linear motor capable of attaining thinning.

### Means for Solving the Problems

In order to attain the aforementioned object, a linear motor according to a first aspect of the present invention includes a spiral coil and a movable portion, including a first pole face having a first polarity and a second pole face having a second polarity different from the first polarity on a surface opposed to the spiral coil, provided to be movable in a direction along the surface of the spiral coil.

A mobile device according to a second aspect of the present invention has the linear motor according to the aforementioned first aspect.

### Effects of the Invention

In the linear motor according to the first aspect of the present invention, thinning can be attained due to the aforementioned structure.

In the mobile device according to the second aspect of the present invention, thinning can be attained due to the aforementioned structure.

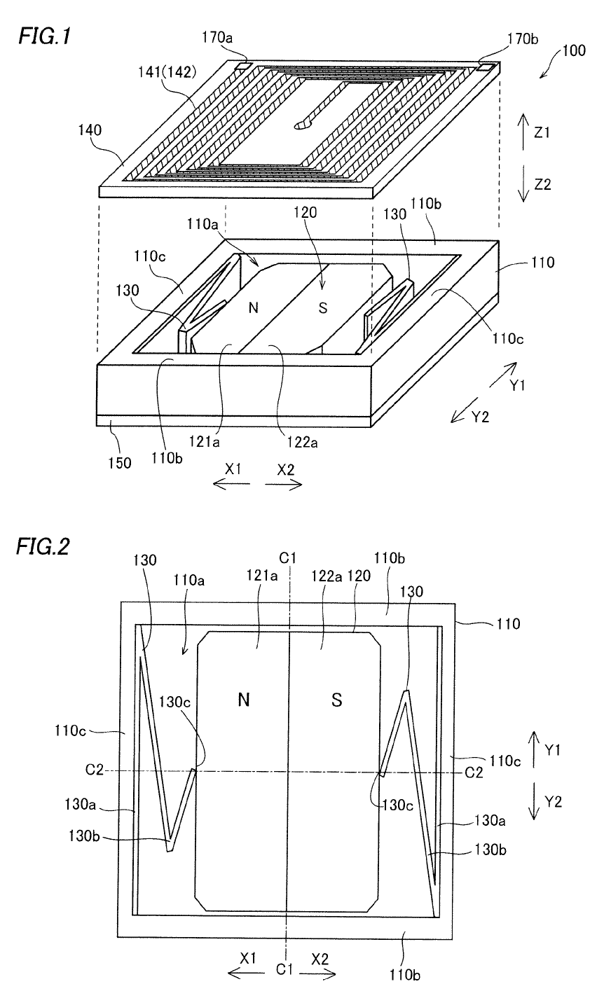

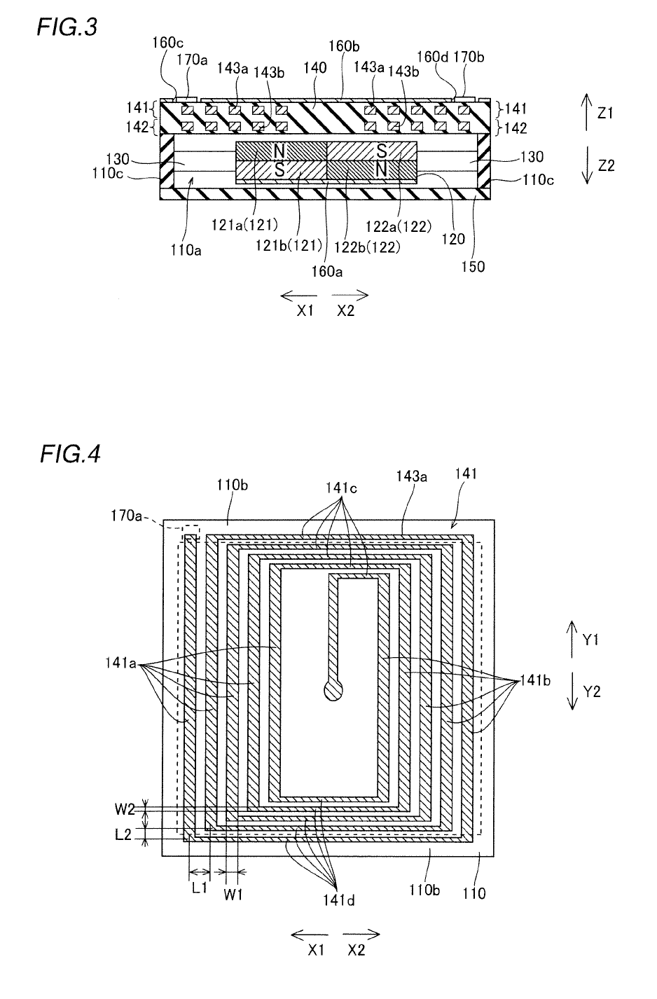

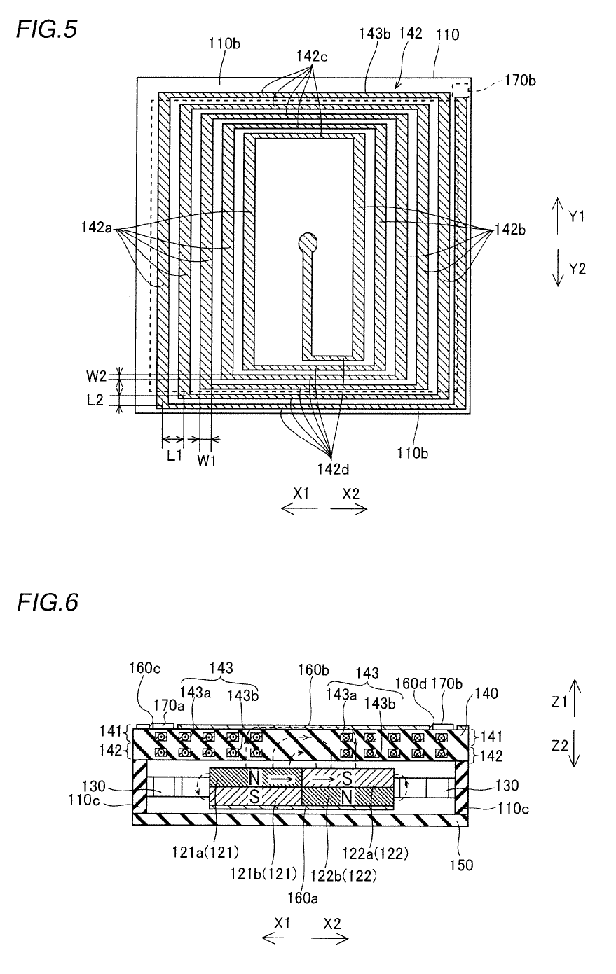

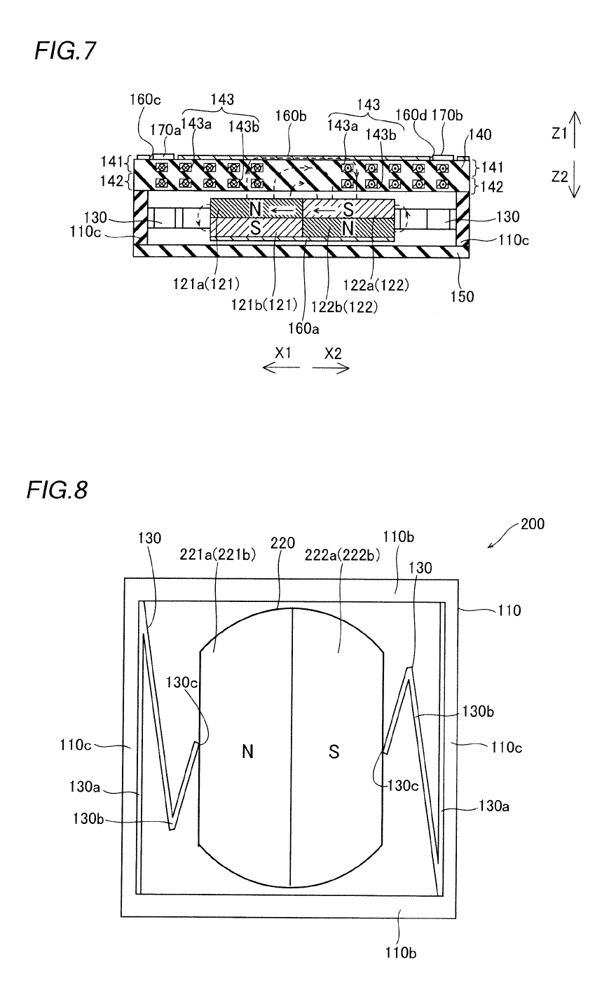

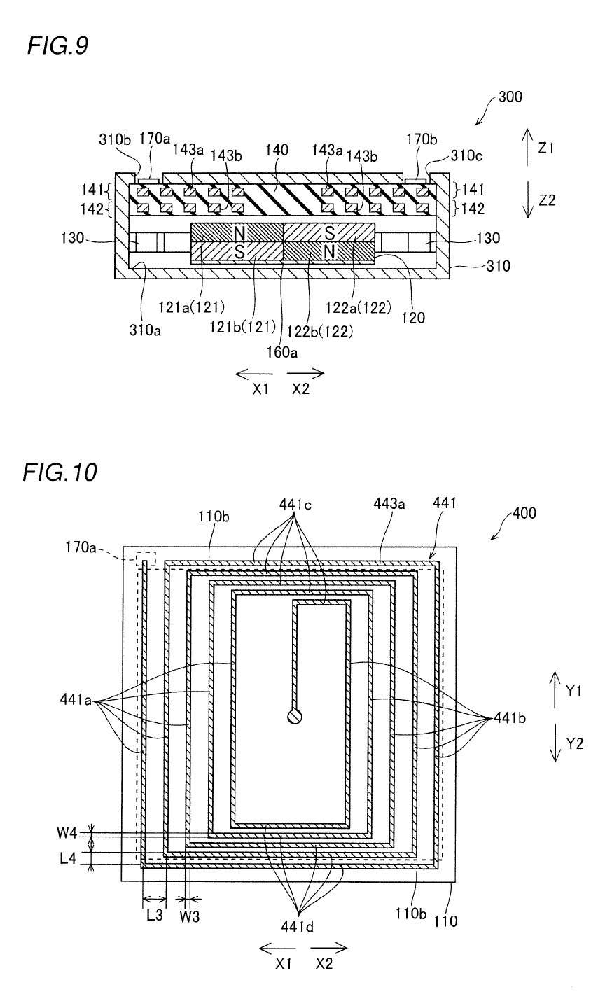

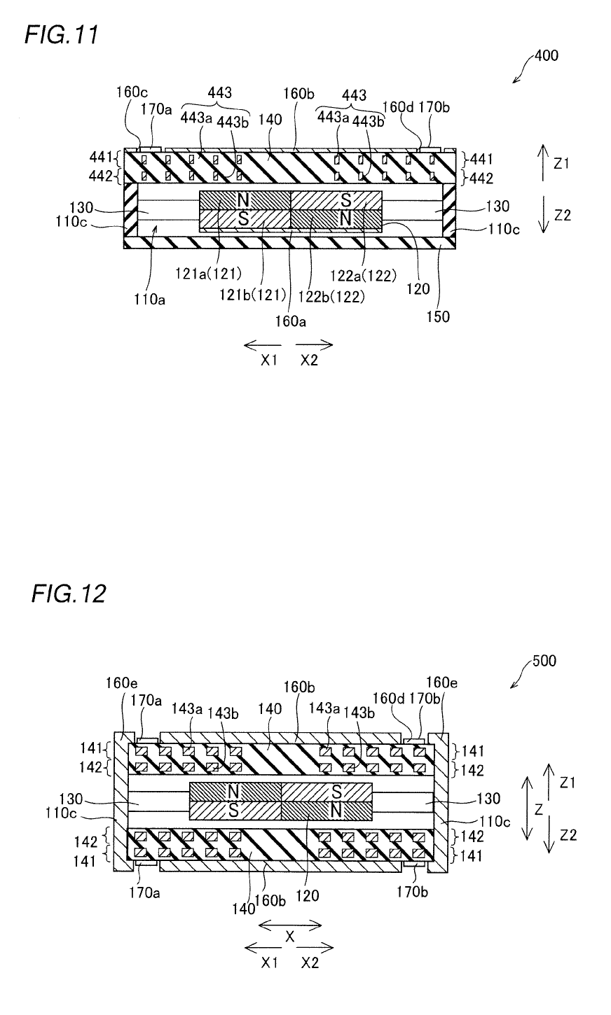

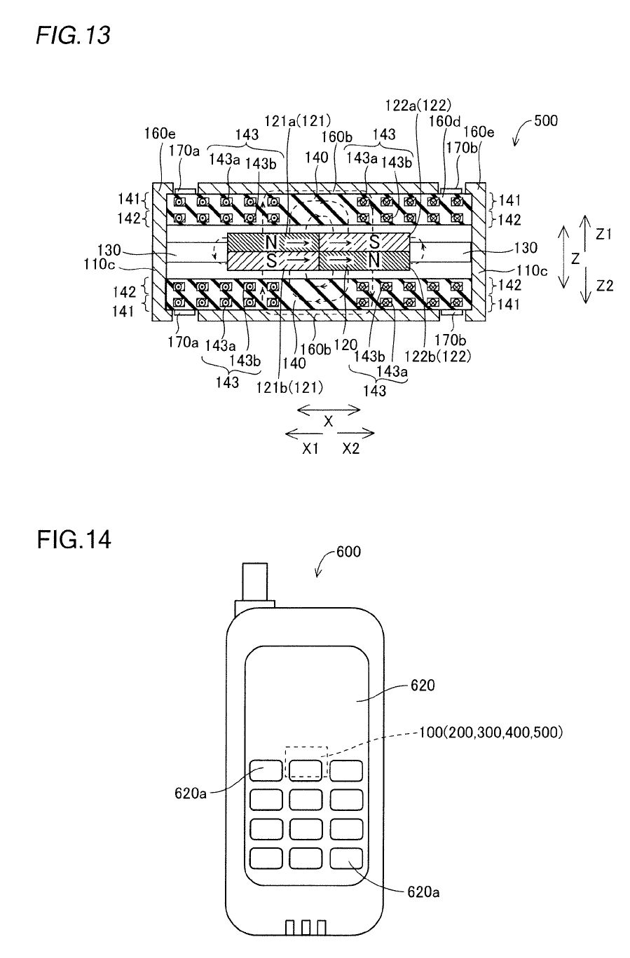

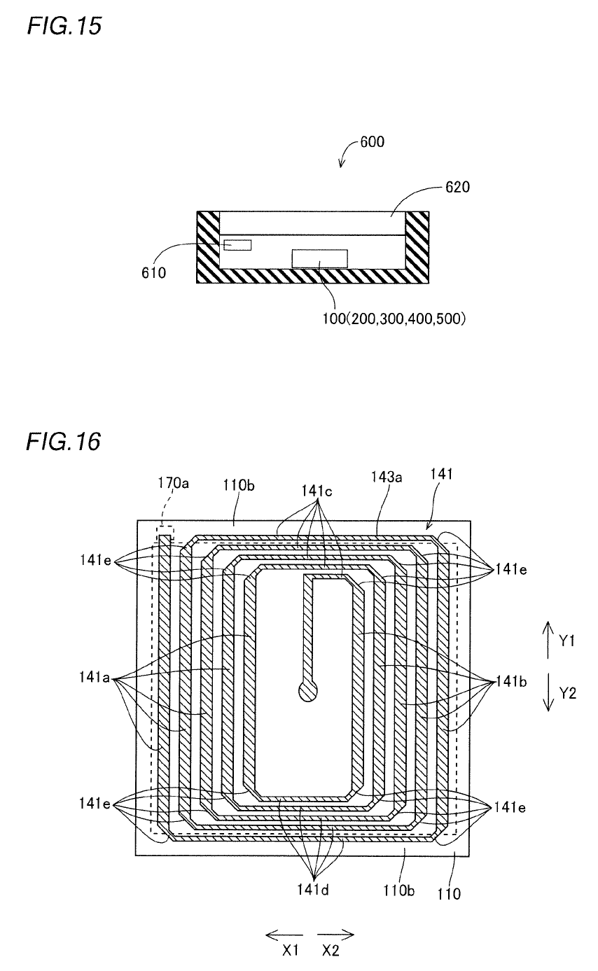

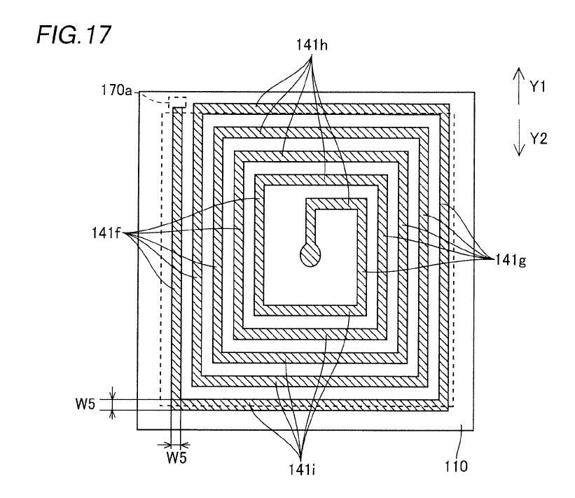

### BRIEF DESCRIPTION OF THE DRAWINGS

[FIG. 1] A perspective view showing the structure of a linear motor according to a first embodiment of the present invention.

[FIG. 2] A plan view of the linear motor according to the first embodiment.

[FIG. 3] A sectional view of the linear motor according to the first embodiment.

[FIG. 4] A plan view showing a first layer of a planar coil of the linear motor according to the first embodiment.

[FIG. 5] A plan view showing a second layer of the planar coil of the linear motor according to the first embodiment.

[FIG. 6] A sectional view for illustrating an operation of the linear motor according to the first embodiment.

[FIG. 7] A sectional view for illustrating another operation of the linear motor according to the first embodiment.

[FIG. 8] A plan view of a linear motor according to a second embodiment of the present invention.

[FIG. 9] A sectional view of a linear motor according to a third embodiment of the present invention.

[FIG. 10] A sectional view of a linear motor according to a fourth embodiment of the present invention.

[FIG. 11] A plan view of the linear motor according to the fourth embodiment of the present invention.

[FIG. 12] A sectional view of a linear motor according to a fifth embodiment of the present invention.

[FIG. 13] A sectional view for illustrating an operation of the linear motor according to the fifth embodiment.

[FIG. 14] A plan view showing the structure of a mobile device according to a sixth embodiment of the present invention.

[FIG. 15] A sectional view showing the structure of the mobile device according to the sixth embodiment of the present invention.

[FIG. 16] A plan view for illustrating a modification of the first to fifth embodiments of the present invention.

[FIG. 17] A plan view for illustrating another modification of the first to fifth embodiments of the present invention.

### MODES FOR CARRYING OUT THE INVENTION

Embodiments of the present invention are now described with reference to the drawings.

### First Embodiment

A linear motor (linear-driven vibrating motor) 100 according to a first embodiment of the present invention includes a frame body 110 provided with a storage portion 110a, a movable portion 120 arranged in the storage portion 110a and a pair of plate springs 130 supporting the movable portion 120, as shown in FIGS. 1 and 2. The frame body 110 is an example of a “housing” in the present invention. The plate springs 130 are examples of the “plate spring member” in the present invention.

The frame body 110 is formed in a substantially rectangular shape (square shape) by first sidewall portions 110b extending in directions of arrows X1 and X2 and second sidewall portions 110c extending in directions of arrows Y1 and Y2 in plan view. The first sidewall portions 110b are examples of an “inner side surface” in the present invention. The storage portion 110a of the frame body 110 is formed by a rectangular opening passing therethrough in the vertical direction (directions of arrows Z1 and Z2). On the frame body 110, a printed board 140 is arranged to block the opening of the storage portion 110a on the side of the upper direction (side of the direction of arrow Z1), while a bottom plate 150 is arranged to block the opening on the side of the lower direction (side of the direction of arrow Z2). The frame body 110, the printed board 140 and the bottom plate 150 are made of glass epoxy resin.

The movable portion 120 is formed in a rectangular shape (oblong shape) whose corner portions are chamfered in plan view as shown in FIG. 2, and constituted of a flat plate-shaped permanent magnet (magnet made of a ferromagnetic material such as ferrite or neodymium). The movable portion 120 has a length of about 8 mm along the directions of arrows X1 and X2, and has a length of about 10 mm along the directions of arrows Y1 and Y2. Side surfaces of the movable portion 120 in the direction (direction of arrow X1 (X2)) of movement thereof are supported by the pair of plate springs 130 so that the movable portion 120 is located substantially at the center of the storage portion 110a of the frame body 110 in plan view. As shown in FIG. 3, the movable portion 120 has a height (small thickness) lower than the height of the storage portion 110a.

The movable portion 120 is constituted of two permanent magnets consisting of a first magnet 121 and a second magnet 122, as shown in FIG. 3. More specifically, the movable portion 120 is so formed that the first magnet 121 is arranged on the side of the direction of arrow X1 and the second magnet 122 is arranged on the side of the direction of arrow X2 trough a portion (see FIG. 2) around a centerline C1-C1 of the movable portion 120. A north pole face 121a magnetized to the north pole in the thickness direction is provided on a side of the first magnet 121 opposed to the printed board 140. A south pole face 122a magnetized to the south pole in the thickness direction is provided on a side of the second magnet 122 opposed to the printed board 140. The north pole and the south pole are examples of the “first polarity” and the “second polarity” in the present invention respectively, while the north pole face 121a and the south pole face 122a are examples of the “first pole face” and the “second pole face” in the present invention respectively.

A south pole face 121b magnetized to the south pole in the thickness direction is provided on a side of the first magnet 121 opposed to the bottom plate 150. Similarly, a north pole face 122b magnetized to the north pole in the thickness direction is provided on a side of the second magnet 122 opposed to the bottom plate 150. The south pole face 121b and the north pole face 122b are examples of the “third pole face” and the “fourth pole face” in the present invention respectively.

The first magnet 121 and the second magnet 122 are so arranged that the north pole face 121a and the south pole face 122a are adjacent to each other on the surfaces closer to the printed board 140 while the south pole face 121b and the north pole face 122b are adjacent to each other on the surfaces closer to the bottom plate 150. The first magnet 121 and the second magnet 122 are held in a state being in close contact with each other due to the attraction between the north pole face 121a and the south pole face 122a adjacent to each other and the attraction between the south pole face 121b and the north pole face 122b, and fixed to each other with an adhesive or the like.

Thus, the movable portion 120 linearly moves in the directions of arrows X1 and X2 parallel to the printed board 140 in the storage portion 110a, in the state supported by the pair of plate springs 130. Here, “parallel” includes not only a state parallel to each other but also a state (state inclined by a prescribed angle) deviating from the parallel state to a degree not hindering the movable portion 120 at the time of the linear movement. At this time, the first sidewall portions 110b (see FIG. 2) have functions as guides when the movable portion 120 moves in the directions of arrows X1 and X2.

The pair of plate springs 130 are arranged on the inner side surfaces of the second sidewall portions 110c of the frame body 110 respectively, as shown in FIGS. 1 and 2. More specifically, the pair of plate springs 130 are constituted of fixed portions 130a fixed to the frame body 110, flexible portions 130b and support portions 130c for the movable portion 120 respectively. The fixed portions 130a are formed to extend along the directions of arrows Y1 and Y2, and fixed to the second sidewall portions 110c of the frame body 110 with an adhesive or the like. The flexible portions 130b are formed to be warpable by being bent a plurality of times (twice) from boundary portions between the same and the fixed portions 130a up to the support portions 130c so that loci of the support portions 130c of the pair of plate springs 130 linearly move on a centerline C2-C2 along the directions of arrows X1 and X2, and have functions of mutually urging the movable portion 120 toward the plate springs 130 on the other sides. The support portions 130c of the respective plate springs 130 are formed to support the movable portion 120 in a holding manner in the vicinity of the centerline C2-C2 of the storage portion 110a of the frame portion 110 respectively.

A yoke 160a formed by an iron plate or the like is provided on the surfaces of the first magnet 121 and the second magnet 122 on the side opposed to the bottom plate 150. Another yoke 160b formed by an iron plate or the like is provided also on the surface of the printed board 140 opposite to the side opposed to the movable portion 120. The yokes 160a and 160b have functions as magnetic shields for inhibiting magnetism from leaking outward from an apparatus body.

Flat-shaped planar coils 141 and 142 consisting of two-layer wiring structures are arranged in the printed board 140, as shown in FIGS. 3 to 5. The planar coils 141 and 142 have rectangular contours in plan view, and are spirally formed to spread in the direction of an X-Y plane (plane formed by the direction of arrow X1 (X2) and the direction of arrow Y1 (Y2)) outward from the inner sides respectively. The planar coils 141 and 142 are examples of the “coil” in the present invention respectively.

The planar coils 141 and 142 are electrically connected in series to each other by one current line 143. More specifically, a first-layer current line 143a constituting the planar coil 141 is spirally wound anticlockwise inward from the outer side, as shown in FIG. 4. An outer end portion of the first-layer current line 143a of the planar coil 141 is connected to an electrode pad 170a provided on the printed board 140.

A second-layer current line 143b constituting the planar coil 142 is spirally wound anticlockwise outward from the inner side, as shown in FIG. 5. An outer end portion of the second-layer current line 143b of the planar coil 142 is connected to another electrode pad 170b provided on the printed board 140. An inner end portion of the first-layer current line 143a constituting the planar coil 141 and an inner end portion of the second-layer current line 143b constituting the planar coil 142 are connected with each other through a contact hole provided in the printed board 140 in the vicinity of the respective central portions thereof. The yoke 160b is provided with openings 160c and 160d in positions corresponding to the electrode pads 170a and 170b on the printed board 140 respectively, while the yoke 160c and the electrode pads 170a and 170b are not in contact with each other.

As shown in FIG. 4, the planar coil 141 has first portions 141a and 141b extending in the directions of arrows Y1 and Y2 and second portions 141c and 141d extending in the directions of arrows X1 and X2 respectively. The width W2 of the current line 143a constituting the second portions 141c and 141d is formed to be smaller than the width W1 of the current line 143a constituting the first portions 141a and 141b of the planar coil 141. Thus, the pitch (distance between the centers of adjacent portions of the current line 143a) L2 of the current line 143a constituting the second portions 141c and 141d is smaller than the pitch L1 of the current line 143a constituting the first portions 141a and 141b. Consequently, the magnitude of magnetic flux of a magnetic field generated by current flowing in the first portions 141a and 141b is larger than the magnitude of magnetic flux of a magnetic field generated by current flowing in the second portions 141c and 141d.

At least parts of the second portions 141c and 141d are arranged to overlap the first sidewall portions 110b of the frame body 110 respectively in plan view. In other words, the arrangement region of the planar coil 141 is larger than the movable portion 120 in plan view, and covers the overall movable portion 120.

As shown in FIG. 5, the planar coil 142 is also similar in structure to the planar coil 141, and has first portions 142a and 142b extending in the directions of arrows Y1 and Y2 and having the width W1 and second portions 142c and 142d extending in the directions of arrows X1 and X2 and having the width W2. Further, parts of the second portions 142c and 142d are arranged to overlap the first sidewall portions 110b of the frame body 110 respectively in plan view.

The first portions 141a (142a) of the planar coil 141 (142) are superposed on the north pole face 121a of the movable portion 120 and the first portions 141b (142b) are superposed on the south pole face 122a in plan view, in a stationary state.

Thus, when driving current is supplied to the planar coils 141 and 142, current directions are opposite to each other in the first portions 141a (142a) and the first portions 141b (142b). Electromagnetic force resulting from the first portions 141a (142a) and the first portions 141b (142b) becomes driving force for moving the movable portion 120.

Operations of the linear motor 100 according to the first embodiment of the present invention are now described with reference to FIGS. 4 to 7.

First, driving current is supplied to the current line 143 through the electrode pads 170a and 170b. Thus, current flows in the first portions 141a (142a) of the planar coil 141 (142) from the rear side of the plane of the figure to the front side, as shown in FIG. 6. In the first portions 141b (142b) of the planar coil 141 (142), current flows from the front side of the plane of the figure to the rear side.

The direction of a magnetic field generated between the north pole face 121a and the south pole face 122a of the movable portion 120 is a direction from the surface of the north pole face 121a toward the printed board 140, i.e., the direction Z1 on the north pole face 121a, as shown by arrows of broken lines in FIG. 6. On the south pole face 122a, it is a direction from the printed board 140 toward the south pole face 122a, i.e., the direction Z2. Thus, it follows that the direction of the magnetic field generated between the north pole face 121a and the south pole face 122a is orthogonal to the directions where the current flows in the first portions 141a (142a) and the first portions 141b (142b) of the planar coil 141 (142). Therefore, the current flowing in the first portions 141a (142a) of the planar coil 141 (142) receives force from the magnetic field of the north pole face 121a of the first magnet 121 in the direction of arrow X1. At the same time, the current flowing in the first portions 141b (142b) of the planar coil 141 (142) receives force from the magnetic field of the south pole face 122a of the second magnet 122 in the direction of arrow X1. However, the first portions 141a (142a) of the planar coil 141 (142) and the first portions 141b (142b) of the planar coil 141 (142) are fixed to the printed board 140, whereby the movable portion 120 is linearly moved in the direction of arrow X2 due to reaction.

After a prescribed time, driving current in a direction opposite to the state shown in FIG. 6 is supplied as shown in FIG. 7, whereby the movable portion 120 is linearly moved in the direction of arrow X1, due to action similar to the above. Thus, the direction of the driving current is so switched at a prescribed frequency that the movable portion 120 is alternately linearly moved and resonated in the direction of arrow X1 and the direction of arrow X2. At this time, magnetic flux generated between the south pole face 121b of the first magnet 121 and the north pole face 122b of the second magnet 122 is absorbed by the yoke 160a and selectively passes through the yoke 160a, whereby the same is not generated to reach the outer side through the bottom plate 150. Further, magnetic flux generated between the north pole face 121a of the first magnet 121 and the south pole face 122a of the second magnet 122 is absorbed by the yoke 160b and selectively passes through the yoke 160b when penetrating the printed board 140, whereby the same is not generated to reach the outer side of the yoke 160b.

At this time, force in directions toward the center along the directions of arrows Y1 and Y2 or force in outwardly pulling directions along the directions of arrows Y1 and Y2 from the center is applied to the movable portion 120, due to electromagnetic force generated from the second portions 141c (142c) and 141d (142d) opposed to each other in the planar coil 141 (142) respectively.

In the linear motor 100 according to the first embodiment of the present invention, the following effects can be attained:

(1) The linear motor 100 of transverse vibration (vibration in the directions of arrows X1 and X2) is so constituted that thinning can be easily attained as compared with a linear motor of longitudinal vibration (vibration in the directions of arrows Z1 and Z2).

(2) The movable portion 120 movable along the directions (directions of arrows X1 and X2) along the surfaces of the planar coils 141 and 142 has been provided. Thus, as compared with a case of linearly moving the movable portion 120 in the vertical direction with a coil having a large thickness in the vertical direction (direction Z), no moving range (moving space in the vertical direction) for the movable portion 120 may be provided, whereby flexibility in design for reducing the thickness in the direction can be ensured. Consequently, the linear motor 100 allowing attainment of thinning can be provided.

(3) The planar coils 141 and 142 have been spirally formed to be flat-shaped (planar-shaped) along the directions of movement of the movable portion 120. Thus, as compared with a case where the winding surfaces of the coils are arranged in a direction orthogonal to the directions of movement of the movable portion, no regions toward the height direction (height direction) by the winding surfaces of the coils may be provided, and the thicknesses in the directions of arrows Z1 and Z2 can be reduced. Therefore, thinning of the linear motor 100 can be attained.

(4) The planar coil 141 (142) has been arranged on one side in the thickness direction of the movable portion 120. Thus, as compared with a case of arranging the planar coil 141 (142) on both sides in the thickness direction of the movable portion 120, the thickness of the linear motor 100 can be inhibited from enlargement. Consequently, thinning of the linear motor 100 can be attained.

(5) The movable portion (permanent magnet) 120 including the north pole face 121a and the south pole face 122a having the polarities different from each other on the surface of the side opposed to the planar coil 141 (142) is provided, and the first portions 141a and 141b (142a and 142b) of the planar coil 141 (142) in which the directions where the current flows are opposite to each other have been arranged on positions corresponding to the north pole face 121a and the south pole face 122a respectively. Thus, force applied to the north pole face 121a and the south pole face 122a by the electromagnetic force generated when the current flows in the planar coil 141 (142) is in the same direction, whereby the movable portion 120 can be moved in the direction. In other words, the linear motor can be constituted of one spiral planar coil, whereby the apparatus can be miniaturized (reduced in area).

In a case where the polarity of the magnet on the side opposed to the coils is of only one type, coils must be arranged on both sides respectively in order to move the movable portion in one direction and another direction, and hence miniaturization (area reduction) of the apparatus has a constant limit.

(6) The linear motor has been so formed that the north pole face 121a and the south pole face 122a of the movable portion (permanent magnet) 120 are arranged to be opposed to the surface of the planar coil 141 (142). Thus, a line of magnetic force (pole face where the line of magnetic force is formed) generated from the side of the movable portion 120 and a line of magnetic flux (coil surface where the line of magnetic flux is formed) generated by feeding current to the planar coil 141 (142) become parallel to each other. In the structure described in the aforementioned Japanese Patent Laying-Open No. 2004-174309, on the other hand, a line of magnetic force from the magnet and a line of magnetic flux from the coil are orthogonal to each other. In the structure of the linear motor 100 as compared with the structure described in the aforementioned Japanese Patent Laying-Open No. 2004-174309, therefore, the quantity of overlapping of the line of magnetic force and the line of magnetic flux is large, whereby the driving force at the time of moving the movable portion 120 can be enlarged.

(7) On the surface of the movable portion 120 opposite to the surface opposed to the planar coil 141 (142), the south pole face 121b has been provided on the position corresponding to the north pole face 121a, while the north pole face 122b has been provided on the position corresponding to the south pole face 122a. Thus, The north pole face 121a, the south pole face 122a, the south pole face 121b and the north pole face 122b of the movable portion 120 are so mutually arranged that different magnetic poles are adjacent to each other in the directions (directions of arrows X1 and X2) of movement and the thickness direction (directions of arrows Z1 and Z2) of the movable portion 120. Therefore, the length of magnetic flux generated between the respective pole faces decreases, whereby the magnetic flux can be inhibited from leaking out of the linear motor 100. Consequently, in a case of arranging the linear motor 100 in various apparatuses, occurrence of malfunction of the apparatuses resulting from magnetic flux leakage from the linear motor 100 can be suppressed.

(8) The yoke 160a having the function as the magnetic shield is so provided on the surfaces of the south pole face 121b and the north pole face 122b of the movable portion 120 that the magnetic flux generated between the south pole face 121b and the north pole face 122b can be reliably inhibited from leaking outward from the side of the bottom plate 150 of the linear motor 100. Further, the yoke 160b is arranged also on the surface of the printed board 140, whereby magnetic flux is generated between the north pole face 121a and the south pole face 122a to pass through the yoke 160b while penetrating the planar coils 141 and 142. Therefore, the magnetic flux generated between the north pole face 121a and the south pole face 122a can be reliably inhibited from leaking outward from the side of printed board 140. Thus, outward magnetic flux leakage from the linear motor 100 can be easily suppressed.

(9) The pair of plate springs 130 supporting the movable portion 120 from both sides in the directions of movement are provided in such shapes that the support portions 130c for the movable portion 120 are bent to warp along the directions (directions of arrows X1 and X2) of movement of the movable portion 120, whereby the loci of the support portions 130c of the plate springs 130 linearly move along the directions of arrows X1 and X2. Thus, the support portions 130c support both sides in the directions of movement of the movable portion 120 while linearly moving along the directions of arrows X1 and X2, whereby contact portions between the support portions 130c and the movable portion 120 can be inhibited from occurrence of deviation when the movable portion 120 moves. Consequently, the movable portion 120 can be inhibited from rotating while moving, whereby the linear motor 100 can be stably operated.

(10) The movable portion 120 is provided in the rectangular shape whose corner portions are chamfered, whereby occurrence of hitching between the movable portion 120 and the first sidewall portions 110b of the frame portion 110 can be suppressed when the movable portion 120 moves, as compared with a case of not chamfering the corner portions. Therefore, the movable portion 120 can be more reliably inhibited from rotating due to such hitching.

(11) The planar coil 141 (142) has been provided with the first portions 141a and 141b (142a and 142b) extending in the directions (the direction of arrow Y1 and the direction of arrow Y2) intersecting with the directions where the movable portion 120 moves and the second portions 141c and 141d (142c and 142d) extending in the directions (the direction of arrow X1 and the direction of arrow X2) where the movable portion 120 moves. Further, the same has been so formed that the pitch L2 of the adjacent portions of the current line 143a (143b) in the second portions 141c and 141d (142c and 142d) is smaller than the pitch L1 of the adjacent portions of the current line 143a (143b) in the first portions 141a and 141b (142a and 142b).

Thus, the lengths of the first portions 141a and 141b (142a and 142b) in the direction of arrow Y1 and the direction of arrow Y2 enlarge due to the reduction of the pitch L2 of the second portions 141c and 141d (142c and 142d), whereby the electromagnetic force for moving the movable portion 120 can be increased, and the response time of the movable portion 120 can be reduced.

(12) The width W2 of the current line 143a (143b) in the second portions 141c and 141d (142c and 142d) has been so reduced to form the same so that the pitch L2 between the adjacent portions of the current line 143a (143b) in the second portions 141c and 141d (142c and 142d) is smaller than the pitch L1 between the adjacent portions of the current line 143a (143b) in the first portions 141a and 141b (141a and 142b). Thus, resistance of the current line 143a (143b) can be reduced due to the large width W1 of the current line 143a (143b) in the first portions 141a and 141b (142a and 142b), whereby the quantity of the current flowing in the current line 143a (143b) can be enlarged. Consequently, the driving force for the movable portion 120 can be increased.

(13) Parts of the second portions 141c (142c) and 141d (142d) of the planar coil 141 have been arranged to overlap the first sidewall portions 110b in plan view. Thus, a region where force in the directions of arrows Y1 and Y2 acts on the movable portion 120 can be reduced, whereby the movable portion 120 can be inhibited from deviating from a linear moving path due to the force in the directions of arrows Y1 and Y2 when linearly moving in the directions of arrows X1 and X2. Consequently, the linear motor 100 can be stably operated. Further, parts of the second portions 141c and 141d (142c and 142d) so overlap the first sidewall portions 110b of the frame body 110 that the lengths of the first portions 141a and 141b (142a and 142b) contributing to generation of the electromagnetic force for moving the movable portion 120 can be further enlarged, whereby the driving force for the movable portion 120 can be increased.

(14) The direction of the current flowing in the first portions 141a (142a) of the planar coil 141 (142) opposed to the north pole face 121a and the direction of the current flowing in the first portions 141b (142b) of the planar coil 141 (142) opposed to the south pole face 122a are substantially opposite directions. Thus, force of the same direction acts on the first portions 141a (142a) of the planar coil 141 (142) opposed to the north pole face 121a and the first portions 141b (142b) of the planar coil 141 (142) opposed to the south pole face 122a, whereby the movable portion 120 can be easily driven.

(15) The upper-layer planar coil 141 and the lower-layer planar coil 142 have been connected with each other so that the current flows in the same direction in the upper-layer planar coil 141 and the lower-layer planar coil 142 corresponding to the upper-layer planar coil 141. Thus, magnetic flux of the same direction can be generated in both coils of the upper-layer planar coil 141 and the lower-layer planar coil 142. Consequently, larger magnetic flux can be generated as compared with a case of providing either the upper-layer planar coil 141 or the lower-layer planar coil 142.

### Second Embodiment

Referring to FIG. 8, an example of employing a movable portion 220 having such a shape that both ends of a circular shape in directions of movement are cut off is described in a second embodiment, dissimilarly to the first embodiment employing the movable portion 120 having the rectangular shape whose corner portions are chamfered.

The movable portion 220 is formed in such a shape that both ends of a circular shape in directions of movement are cut off in plan view. The movable portion 220 has a north pole face 221a magnetized to the north pole in the thickness direction and a south pole face 222a magnetized to the south pole in the thickness direction on a surface of a side opposed to planar coils 141 and 142, similarly to the first embodiment. Further, the movable portion 220 is provided on a surface opposite to the surface opposed to the planar coil 141 (142) with a south pole face 221b magnetized to the south pole in the thickness direction in a region corresponding to the north pole face 221a. A north pole face 222b magnetized to the north pole in the thickness direction is provided on a region corresponding to the south pole face 222b.

The remaining structure and operations of the second embodiment are similar to those of the first embodiment.

In a linear motor 200 according to the second embodiment of the present invention, the following effects can be attained, in addition to the aforementioned effects (1) to (13):

(16) The movable portion 220 has been brought into such a shape that both ends of a circular shape in directions of movement are cut off in plan view. Thus, the quantity of movement (moving range) of the movable portion spreads by the ranges of the cut-off portions as compared with a case of employing a circular movable portion, whereby a range for accelerating the movable portion 220 can be spread. Therefore, the quantity of vibration of the linear motor 200 can be increased.

(17) As compared with the movable portion 120 of the first embodiment coming into surface contact with the first sidewall portions 110b having the functions as the guides in the case of moving the movable portion 220 in the directions of arrows X1 and X2, the movable portion 220 of the second embodiment comes into line contact with first sidewall portions 110b, whereby frictional resistance can be reduced. Therefore, the movable portion 220 can be more stably operated.

### Third Embodiment

In a linear motor 300 according to a third embodiment, an example of integrally forming portions corresponding to a frame portion, a bottom portion and a yoke dissimilarly to the first embodiment separately forming the frame portion 110, the bottom plate 150 and the yoke 160b respectively is described, as shown in FIG. 9.

In the linear motor 300, a movable portion 120 and a printed board 140 are arranged in a housing 310 formed in a rectangular tubular shape. The housing 310 is made of iron, for example, and has a function as a magnetic shield for inhibiting magnetism generated from the movable portion 120 from leaking outward. In this case, a lid portion (not shown) or the like is mounted on an opening 130a, after arranging the printed board 140 in the interior by sliding the same from the opening 310a of the housing 310. The housing 310 is provided with openings 310b and 310c in positions corresponding to electrode pads 170a and 170b of the printed board 140.

The remaining structure and operations of the third embodiment are similar to those of the first embodiment.

In the linear motor 300 according to the third embodiment of the present invention, the following effect can be attained, in addition to the aforementioned effects (1) to (15):

(18) The housing 310 having the function as the magnetic shield is so provided as to cover the movable portion 120 formed by a permanent magnet that magnetic flux generated from the movable portion 120 can be easily inhibited from leaking outward. Further, the housing as the frame portion, the bottom plate and the yoke is so integrally provided that the number of components can be suppressed as compared with a case of separately providing the same respectively.

### Fourth Embodiment

Referring to FIGS. 10 and 11, an example of equalizing the magnitudes of the widths of first portions 441a (441b) and second portions 441c (441d) of a planar coil 441 to each other is described in a fourth embodiment, dissimilarly to the first embodiment forming the first portions 141a (141b) and the second portions 141c (141d) of the planar coil 141 with the widths of different magnitudes.

In a linear motor 400, the planar coil 441 formed by a current line 443 has the first portions 441a and 441b extending in directions of arrows Y1 and Y2 and the second portions 441c and 441d extending in directions of arrows X1 and X2, as shown in FIG. 10. The width W3 of portions of a first-layer current line 443a constituting the first portions 441a and 441b of the planar coil 441 is substantially equal to the width W4 of portions of the current line 443a constituting the second portions 441c and 441d. The planar coil 441 is so formed that the pitch L4 (distance between the centers of adjacent portions of the current line 443a) constituting the second portions 441c and 441d is smaller than the pitch L3 of the portions of the current line 443a constituting the first portions 441a and 441b.

Parts of the second portions 441c and 441d are arranged to overlap first sidewall portions 110b of a frame body 110 respectively in plan view. In other words, an arrangement region of the planar coil 441 is larger than a movable portion 120 in plan view, and arranged to cover the overall movable portion 120. The structure of a second-layer current line 443b (planar coil 442) shown in FIG. 11 is similar to that of the aforementioned first-layer current line 443a (planar coil 441). The remaining structure of the fourth embodiment is similar to that of the aforementioned first embodiment.

In the linear motor 400 according to the fourth embodiment of the present invention, the following effect can be attained, in addition to the aforementioned effects (1) to (10) and (13) to (15):

(19) The planar coil 441 has been provided with the first portions 441a and 441b extending in the directions (the direction of arrow Y1 and the direction of arrow Y2) intersecting with directions where the movable portion 120 moves and the second portions 441c and 441d extending in the directions (the direction of arrow X1 and the direction of arrow X2) where the movable portion 120 moves. Further, the same has been so formed that the pitch L4 of the adjacent portions of the current line 443a in the second portions 441c and 441d is smaller than the pitch L3 of the adjacent portions of the current line 443a in the first portions 441a and 441b.

Thus, the pitch L4 of the second portions 441c and 441d so decreases that the lengths of the first portions 441a and 441b in the direction of arrow Y1 and the direction of arrow Y2 enlarge, whereby electromagnetic force for moving the movable portion 120 can be increased, and the response time of the movable portion 120 can be reduced.

### Fifth Embodiment

Referring to FIGS. 4, 5 and 12, an example of arranging printed boards 140 on both sides of surfaces of a movable portion 120 respectively is described in a fifth embodiment, dissimilarly to the first embodiment in which the printed board 140 including the planar coils 141 and 142 is arranged only on one side of the surface of the movable portion 120.

In a linear motor 500, the printed boards 140 on which upper-layer planar coils 141 and lower-layer 142 are arranged are arranged on a side of the movable portion 120 in one direction (direction of arrow Z1) in the thickness direction (direction Z) and another side of the movable portion 120 in another direction (direction of arrow Z2) in the thickness direction (direction Z), as shown in FIG. 12. The planar coils 141 are spirally wound anticlockwise inward from the outer sides in plan view, similarly to the shape shown in FIG. 4. The planar coils 142 are spirally wound anticlockwise outward from the inner sides in plan view, similarly to the shape shown in FIG. 5.

In the case of arranging the printed boards 140 on both sides of the movable portion 120, no yoke 160a is mounted on the movable portion 120, but yokes 160b are provided on both sides of an apparatus body in the direction along the direction Z. Thus, outward magnetic flux leakage from the linear motor 500 is suppressed. Further, yokes 160e are provided on both sides of the apparatus body in a direction along a direction X. Thus, outward magnetic flux leakage from the linear motor 500 is suppressed.

An operation of the linear motor 500 according to the fifth embodiment of the present invention is now described with reference to FIG. 13.

First, driving current is supplied to current lines 143 through electrode pads 170a and 170b. Thus, current flows in first portions 141a (142a) of the planar coils 141 (142) arranged on both sides of the movable portion 120 in the thickness direction (direction Z) from the rear side of the plane of the figure to the front side, as shown in FIG. 13. Further, current flows in first portions 141b (142b) of the planar coils 141 (142) from the front side of the plane of the figure to the rear side.

The direction of a magnetic field generated between a north pole face 121a and a south pole face 122a of the movable portion 120 is the direction Z1 on the north pole face 121a, and the direction Z2 on the south pole face 122a. The direction of a magnetic field generated between a north pole face 122b and a south pole face 121b of the movable portion 120 is the direction Z2 on the north pole face 122b, and the direction Z1 on the south pole face 121b.

Therefore, the current flowing in the first portions 141a (142a) of the planar coils 141 (142) receives force from the magnetic field of the north pole face 121a and the south pole face 121b of a first magnet 121 in the direction of arrow X1. At the same time, the current flowing in the first portions 141b (142b) of the planar coils 141 (142) receives force from the magnetic field of the south pole face 122a and the north pole face 122b of a second magnet 122 in the direction of arrow X1. However, the planar coils 141 (142) are fixed to the printed boards 140, whereby the movable portion 120 is linearly moved in the direction of arrow X2 by reaction.

After a prescribed time, driving current in a direction opposite to the state shown in FIG. 13 is supplied, whereby the movable portion 120 is linearly moved in the direction of arrow X1 due to action similar to the above. Thus, the direction of the driving current is so switched at a prescribed frequency that the movable portion 120 is alternately linearly moved and resonated in the direction of arrow X1 and the direction of arrow X2.

In the linear motor 500 according to the fifth embodiment of the present invention, the following effect can be attained, in addition to the aforementioned effects (1) to (3), (6), (7) and (9) to (19):

(20) The planar coils 141 and 142 have been arranged on both sides of the movable portion 120 in the thickness direction (direction Z). Thus, the movable portion 120 is driven by electromagnetic force of the current flowing in the planar coils 141 and 142 arranged on both sides of the movable portion 120, whereby driving force for the movable portion 120 can be improved. Consequently, the response time (time up to when the movable portion 120 reaches a prescribed quantity of vibration) of the movable portion 120 can be reduced.

### Sixth Embodiment

The linear motor 100 (200 to 500) according to any of the first to fifth embodiments of the present invention can be employed for a mobile phone 600 or the like, as shown in FIGS. 14 and 15. The mobile phone 600 includes the linear motor 100 (200 to 500), a CPU 610 (see FIG. 15) and a display portion 620. The linear motor 100 is arranged on a side of the mobile phone 600 opposite to the side where the display portion 620 is arranged. The display portion 620 is constituted of a touch panel-system panel, and so formed that the user operates the mobile phone 600 by pressing button portions 620a displayed on the display portion 620. The linear motor 100 (200 to 500) is controlled by the CPU 610 to vibrate in a case of sensing that the button portions 620a displayed on the display portion 620 have been pressed, in a case of being set to the silent mode when receiving an incoming call or the like. The mobile phone 600 is an example of the “mobile device” in the present invention.

In the mobile phone 600 including the linear motor 100 (200 to 500) according to the sixth embodiment of the present invention, the following effects can be attained:

(21) The aforementioned linear motor 100 (200 to 500) is so provided as a vibration source that thinning of the mobile phone 600 can be attained since the aforementioned linear motor 100 (200 to 500) is thinned.

(22) The aforementioned linear motor 100 (200 to 500) is so provided that, also in a case where a ferromagnetic body such as iron approaches the mobile phone 600, resulting influence on the operation of the linear motor 100 (200 to 500) can be reduced since magnetic flux leakage from the linear motor 100 (200 to 500) is suppressed.

The embodiments disclosed this time must be considered as illustrative in all points and not restrictive. The range of the present invention is shown not by the above description of the embodiments but by the scope of claims for patent, and all modifications within the meaning and range equivalent to the scope of claims for patent are further included.

For example, while the example of employing the rectangular movable portion 120 whose corner portions are chamfered in plan view as an example of the movable portion has been shown in the first embodiment, the present invention is not restricted to this. For example, an unchamfered rectangular movable portion may be employed as the movable portion 120. Alternatively, the movable portion 120 may be brought into a shape such as a circular shape other than the rectangular shape.

While the example of constituting the movable portion 120 of the north pole face 121a, the south pole face 122a, the south pole face 121b and the north pole face 122b has been shown in each of the first to fifth embodiments, the present invention is not restricted to this. For example, the movable portion 120 may be constituted of only the north pole face 121a and the south pole face 122a, not to be provided with the south pole face 121b and the north pole face 122b. In other words, pole faces magnetized to mutually different magnetic properties may simply be provided along the surface opposed to the planar coils 141 and 142.

While the example of so providing the movable portion 120 as to render the first magnet 121 and the second magnet 122 adjacent to each other has been shown in each of the first to fifth embodiments, the present invention is not restricted to this. For example, a weight of tungsten or the like may be arranged between the first magnet 121 and the second magnet 122. In this case, the movable portion 120 can be more stably operated, due to the arrangement of the weight. At this time, the weight is so arranged without varying the volume of the movable portion 120 that the weight of the movable portion 120 can be increased in the same volume as compared with the case where the weight is not arranged. Thus, the quantity of vibration of the movable portion 120 can be easily increased.

While the example of providing the yoke 160a on the surfaces of the south pole face 122b and the north pole face 122b of the movable portion 120 has been shown in each of the first to fifth embodiments, the present invention is not restricted to this. For example, the yoke 160a may be arranged to extend from the surfaces of the south pole face 121b and the north pole face 122b to portions of the side surfaces. In this case, magnetic flux leakage in the directions (directions of arrows X1 and X2 in FIG. 3) of the side surfaces of the movable portion 120 can be reliably suppressed.

While the example of movably supporting the movable portion 120 with the two plate springs 130 as examples of elastic members has been shown in each of the first to fifth embodiments, the present invention is not restricted to this. For example, the same may be elastic members such as coil springs or rubber members other than the plate springs. Further, the movable portion 120 may be supported with at least three plate springs 130.

While the example of arranging the printed board 140 on which the planar coils 141 and 142 are arranged on the side of only one surface of the movable portion 120 has been shown in each of the first to fifth embodiments, the present invention is not restricted to this. For example, printed boards 140 may be arranged on the surfaces of both sides of the printed board 140 respectively. Thus, the movable portion 120 is driven from both sides, whereby the driving force for the movable portion 120 can be improved. Consequently, the response time (time up to when the movable portion 120 reaches a prescribed quantity of vibration) of the movable portion 120 can be reduced. In the case of arranging the printed boards 140 on the surfaces of both sides of the movable portion 120, outward magnetic flux leakage from the linear motor 100 (200 to 500) is preferably suppressed by not mounting the yoke 160a on the movable portion 120 but substitutionally providing the yokes 160b on both sides of the apparatus body.

While the example of supporting the movable portion 120 in a holding manner with the support portions 130c of the pair of plate springs 130 has been shown in each of the first to fifth embodiments, the present invention is not restricted to this. For example, the contact portions between the support portions 130c of the plate springs 130 and the movable portion 120 may be bonded to each other. The same are more preferably bonded to each other as the shape of the movable portion 120 approaches a circular shape.

While the example of directly supporting the movable portion 120 with the plate springs 130 has been shown in each of the first to fifth embodiments, the present invention is not restricted to this. For example, the movable portion 120 may be supported with the plate springs 130 in a state arranging magnetic fluid on the surface thereof. In this case, frictional force between the movable portion 120 and the first sidewall portions 110b and frictional force between the movable portion 120 and the bottom plate 150 are reduced due to the arrangement of the magnetic fluid, whereby the response time of the movable portion 120 can be reduced.

While the example of forming the planar coil 141 so that the pitch L2 of all of the second portions 141c (141d) thereof is smaller than the pitch L1 of the first portions 141a (141b) in plan view has been shown in each of the first to fifth embodiments, the present invention is not restricted to this. For example, the planar coil 141 may be so formed that the pitch L2 of parts of the second portions 141c (141d) is smaller than the pitch L1 of the first portions 141a (141b).

While the example of arranging parts of the second portions 141c (141d) of the planar coil 141 to overlap the first sidewall portions 110b of the frame body 110 respectively in plan view has been shown in each of the first to fifth embodiments, the present invention is not restricted to this. For example, all of the second portions 141c (141d) may be provided to overlap the first sidewall portions 110b of the frame body 110.

While the example of forming the planar coil 141 (142) in the spiral shape having the rectangular contour has been shown in each of the first to fifth embodiments, the present invention is not restricted to this. For example, corner portions 141e of the rectangular contour of the planar coil 141 may be formed at an angle other than the right angle such that the same are obliquely formed, as shown in FIG. 16. Particularly in the case of the second embodiment, the movable portion 220 has the shape obtained by cutting off both ends of a circular shape. Thus, in the planar coil 141 whose corner portions are formed at the right angle, the corner portions are not superposed on the movable portion 220, and lines of magnetic flux from these corner portions do not contribute to driving of the movable portion 220. Therefore, the corner portions 141e are so obliquely formed as in the planar coil 141 of FIG. 16 that the total length of the current line 143a constituting the planar coil 141 can be reduced. Thus, the resistance value of the overall planar coil 141 can be reduced, whereby the current flowing in the planar coil 141 can be increased. Consequently, force (electromagnetic force) acting between the planar coil 141 and the movable portion 220 (permanent magnet) can be increased, whereby the driving force for the movable portion 220 can be increased, while the response time of the movable portion 220 can be reduced.

While the example of rendering the width of the second portions 141c (142c) and 141d (142d) smaller than the width of the first portions 141a (142a) and 141b (142b) of the planar coil 141 (142) has been shown in each of the first to fifth embodiments, the present invention is not restricted to this. For example, the widths of first portions 141f and 141g and second portions 141h and 141i may be set to the same magnitude (W5), as shown in FIG. 17. Further, the magnitudes of the widths of the first portions 141a and 141b and the second portions 141c an 141d may be identical to each other, while the line intervals of the first portions 141a and 141b and the line intervals of the second portions 141c and 141d may be different from each other.

While the example of rendering the width of the second portions 141c (142c) and 141d (142d) smaller than the width of the first portions 141a (142a) and 141b (142b) of the planar coil 141 (142) has been shown in each of the first to fifth embodiments, the present invention is not restricted to this. For example, the pitches of the first portions 141a and 141b and the second portions 141c and 141d may be identical to each other, while the width of the first portions 141a and 141b may be larger than the width of the second portions 141c and 141d. Thus, the quantities of the current flowing in the first portions 141a and 141b enlarge, whereby the driving force for the movable portion 120 can be more increased. Further, the width of the second portions 141c and 141d where the electromagnetic force moving the movable portion 120 in directions other than the moving path (directions of arrows X1 and X2) is generated so decreases that the electromagnetic force also decreases, whereby the movable portion 120 can be inhibited from deviating from the moving path. Therefore, the linear motor 100 (200 to 500) can be stably operated.

1. A linear motor (100, 200, 300, 400) comprising:
a spiral coil (141, 142, 441, 442); and
a movable portion (120, 220), including a first pole face (121a) having a first polarity and a second pole face (122a) having a second polarity different from said first polarity on a surface opposed to said spiral coil, provided to be movable in a direction along the surface of said spiral coil.

2. The linear motor according to claim 1, wherein
said movable portion is formed to linearly move in the direction along the surface of said coil, and
the first pole face of said movable portion is formed on the side of one direction in directions of movement of said movable portion while said second pole face is formed on the side of another direction in the directions of movement of said movable portion.

3. The linear motor according to claim 1, wherein
said movable portion includes a third pole face (121b), having said second polarity, provided on a position corresponding to said first pole face and a fourth pole face (122b), having said first polarity, provided on a position corresponding to said second pole face on a surface opposite to the surface opposed to said coil.

4. The linear motor according to claim 3, wherein
said first pole face and said fourth pole face of said movable portion include either the north poles or the south poles, and
said second pole face and said third pole face of said movable portion include either the south poles or the north poles.

5. The linear motor according to claim 1, wherein
said movable portion has a rectangular shape whose corner portions are chamfered in plan view.

6. The linear motor according to claim 1, wherein
said movable portion has such a shape that both ends of a circular shape in directions of movement are cut off.

7. The linear motor according to claim 1, wherein
said spiral coil includes a spiral planar surface-shaped coil.

8. The linear motor according to claim 1, wherein
said spiral coil includes one spiral coil in plan view.

9. The linear motor according to claim 1, wherein
said spiral coil is arranged on one side in the thickness direction of said movable portion.

10. The linear motor according to claim 1, wherein
said spiral coils are arranged on both sides of the side of one direction and the side of another direction in the thickness direction of said movable portion.

11. The linear motor according to claim 1, wherein
said spiral coil includes a first portion (141a, 141b, 141f, 141g, 142a, 142b, 441a, 441b) extending along a direction orthogonal to directions of movement of said movable portion and a second portion (141c, 141d, 141h, 141i, 142c, 142d, 441c, 441d) extending along the directions of movement of said movable portion in plan view.

12. The linear motor according to claim 1, wherein
said spiral coil is formed in a two-layer structure of upper-layer said spiral coil (141, 441) spirally wound inward from the outer side and lower-layer said spiral coil (142, 442) spirally wound outward from the inner side in plan view, and
said upper-layer spiral coil and said lower-layer spiral coil are so connected with each other that current flows in the same direction in a portion of said upper-layer spiral coil and a portion of said lower-layer spiral coil corresponding to the portion of said upper-layer spiral coil.

13. The linear motor according to claim 1, wherein
said movable portion includes a permanent magnet (121, 122) having the first pole face having said first polarity and the second pole face having said second polarity different from said first polarity on the surface opposed to said spiral coil, and
said movable portion is formed to be movable in the direction along the surface of said spiral coil on the basis of a magnetic field generated from said permanent magnet of said movable portion and current flowing in said spiral coil.

14. The linear motor according to claim 1, wherein
corner portions (141e) of a rectangular contour of said spiral coil are obliquely formed in plan view.

15. The linear motor according to claim 1, further comprising a yoke (160a) provided on a surface of said movable portion opposite to the surface opposed to said coil.

16. The linear motor according to claim 1, further comprising a plate spring member (130), linearly movably supporting said movable portion, so bent that a contact portion with respect to said movable portion warps along directions of movement of said movable portion, wherein
said plate spring member is formed to apply elastic force to said movable portion along the directions of movement of said movable portion.

17. The linear motor according to claim 16, wherein
said plate spring members are provided on both sides in the directions of movement of said movable portion.

18. The linear motor according to claim 17, wherein
said plate spring members include support portions (130c) supporting said movable portion, and
said movable portion is arranged to be held between said support portions of said plate spring members provided on both sides of said movable portion in plan view.

19. The linear motor according to claim 18, wherein
contact portions between said movable portion and said support portions of said plate spring members are bonded to each other.

20. A mobile device (500) having a linear motor (100, 200, 300, 400) including a spiral coil (141, 142, 441, 442) and a movable portion (120, 220), having a first pole face (121a) having a first polarity and a second pole face (122a) having a second polarity different from said first polarity on a surface opposed to said spiral coil, provided to be movable in a direction along the surface of said spiral coil.
